(19) United States
(12) Patent Application Publication
(10) Pub. No.: US 2023/0024157 A1
(43) Pub. Date: Jan. 26, 2023

(54) COATING SYSTEM AND ELECTRODE RACK

(71) Applicant: SST Systems, Inc., Sturgeon Bay, WI (US)

(72) Inventors: Tim Splingaire, Sturgeon Bay, WI (US); Anthony E. Herbst, Sturgeon Bay, WI (US); Jeffrey Alan Wienke, Marengo, IL (US); Chad Martin Andreae, Sturgeon Bay, WI (US)

(21) Appl. No.: 17/869,542

(22) Filed: Jul. 20, 2022

Related U.S. Application Data
(60) Provisional application No. 63/225,096, filed on Jul. 23, 2021.

(51) Int. Cl. C25D 17/06; B65G 49/04; B05C 3/10; B05D 7/22; B05D 7/00; C25D 17/00; C25D 17/28; C25D 21/10

(52) U.S. Cl. CPC C25D 17/06; B65G 49/0463; B05C 3/10; B05D 7/22; B05D 7/582; C25D 17/005; C25D 17/28; C25D 21/10

(57) ABSTRACT

An e-coat line includes a frame supporting a process track configured to extend along a process direction, a workpiece rack moveably supported on the frame, and a plurality of electrodes supported on an electrode rack. The rack includes support members configured to hold a plurality of hollow workpieces in a predetermined arrangement, and the workpiece rack is moveable relative to the frame between a raised position and a lowered position. The plurality of electrodes are supported on the electrode rack in a predetermined arrangement complementary to the predetermined arrangement of the plurality of hollow workpieces on the support members. The electrode rack is moveable relative to the workpiece rack in a direction crossing the process direction between a first position, in which the plurality of electrodes are extended along and overlapping with the support members to fit within the plurality of hollow workpieces, and a second position, in which the plurality of electrodes are retracted away from the support members to be removed from the plurality of hollow workpieces.

### CROSS-REFERENCE TO RELATED APPLICATIONS

This application claims priority to U.S. Provisional Patent Application No. 63/225,096, filed Jul. 23, 2021, the entire contents of which are incorporated herein by reference.

### FIELD

The present invention relates to finishing systems and processes for manufactured parts, and more particularly to carriers for transporting manufactured parts through a finishing process and methods relating to the same. For example, a finishing process can include an electrodeposition coating or “e-coat” process whereby manufactured parts are immersed in coating material and the process is charged with electrical current to deposit latent coating material onto immersed manufactured parts. The shape of elongated parts (e.g., pipes, fluid lines, etc.) are taken into consideration during the e-coat process to ensure full coating or covering of inner and outer surfaces.

### BACKGROUND

Typically, large and complex machines will be utilized to ensure complete coating and transportation of such parts. Such machines typically include extensive processes carried out in different containers and/or housings that are separated from one another in order to provide parts with a desirable surface finish.

### SUMMARY

In one aspect, the invention provides a product coating system including a first end, a second end, and a frame extending between the first end and the second end, a pre-coating treatment station disposed between the first end and the second end, a first e-coat station disposed between the pre-coating treatment station and the second end, a second e-coat station disposed between the pre-coating treatment station and the second end, a curing station including an oven having an entrance and an exit, a process track supported on a portion of the frame and selectively moveable between a lowered position and a raised position, the process track extending above the pre-coating treatment station, the first e-coat station, and the second e-coat station, an oven track extending through the oven, a rack configured to carry one or more products, the rack selectively moveable along the process track and the oven track and moveable with the process track to the lowered position, in which the rack is positioned within one of the pre-coating treatment station, the first e-coat station, and the second e-coat station, a first hold up inhibiting the rack from being lowered into the second e-coat station, a second hold up inhibiting the rack from being lowered into the first e-coat station, a first rack path including the pre-coating treatment station, the first e-coat station, the first hold up, and the curing station, and a second rack path including the pre-coating treatment station, the second hold up, the second e-coat station, and the curing station. The rack is sequentially moveable through the first rack path and the second rack path.

In another aspect, the invention provides a method for coating a product including providing a frame having a first end and a second end, supporting a process track on a portion of the frame, and extending the process track above a product pre-coating treatment station, a first product e-coat station, and a second product e-coat station. The product pre-coating treatment station is disposed between the first end and the second end, the first product e-coat station is disposed between the product pre-coating treatment station and the second end, and the second product e-coat station is disposed between the product pre-coating treatment station and the second end. The method further includes selectively moving the process track between a lowered position and a raised position, supporting an oven track on a portion of the frame, extending the oven track through a e-coat cure oven defining a curing station, the cure oven including an entrance and an exit, removably supporting a rack for carrying one or more products on the process track and the oven track, selectively moving the rack along the process track and along the oven track through a first rack path and a second rack path, and sequentially moving the rack through the first rack path and the second rack path. When the process track is in the lowered position, the rack supported on the process track is lowered into one of the product pre-coating treatment station, first product e-coat station, and the second product e-coat station. The first rack path includes the product pre-coating treatment station, the first product e-coat station, a first series of hold ups supported on the frame above the second product e-coat station configured to prevent the rack from being lowered with the process track, and the curing station. The second rack path includes the product pre-coating treatment station, a second series of hold ups supported on the frame above the first product e-coat station configured to prevent the rack from being lowered with the process track, the second product e-coat station, and the curing station.

In another aspect, the invention provides an e-coat line including a frame supporting a process track configured to extend along a process direction, a workpiece rack moveably supported on the frame, the rack including support members configured to hold a plurality of hollow workpieces in a predetermined arrangement, the workpiece rack moveable relative to the frame between a raised position and a lowered position, and a plurality of electrodes supported on an electrode rack in a predetermined arrangement complementary to the predetermined arrangement of the plurality of hollow workpieces on the support members. The electrode rack is moveable relative to the workpiece rack in a direction crossing the process direction between a first position, in which the plurality of electrodes are extended along and overlapping with the support members to fit within the plurality of hollow workpieces, and a second position, in which the plurality of electrodes are retracted away from the support members to be removed from the plurality of hollow workpieces.

Other aspects of the invention will become apparent by consideration of the detailed description and accompanying drawings.

### BRIEF DESCRIPTION OF THE DRAWINGS

FIG. 1 is a front elevation view of a system and method for coating a product according to one embodiment of the present disclosure.

FIG. 2 is a top plan view of the system and method of FIG. 1.

FIG. 3 is a partial end section view of the system and method of FIG. 1 taken through section line 3-3 showing a product rack in a raised and lowered position.

FIG. 4 is a schematic plan view of stations making up a portion of the system and method.

FIG. 5 is a detail view of a product holder supporting a plurality of products.

FIG. 6 is a detail view of a plurality of electrodes within the plurality of products of FIG. 5.

FIG. 7 is a detail view taken through the partial section line 7-7 of FIG. 1, showing the plurality of electrodes of FIG. 6 in a first position retracted from the plurality of products of FIG. 5 and in a second position inserted in the plurality of products of FIG. 5.

### DETAILED DESCRIPTION

Before embodiments are explained in detail, it is to be understood that the invention is not limited in its application to the details of construction and the arrangement of components set forth in the following description or illustrated in the accompanying drawings. The invention is capable of other embodiments and of being practiced or of being carried out in various ways. Also, it is to be understood that the phraseology and terminology used herein is for the purpose of description and should not be regarded as limited. The use of “including,” “comprising” or “having” and variations thereof herein is meant to encompass the items listed thereafter and equivalents thereof as well as additional items.

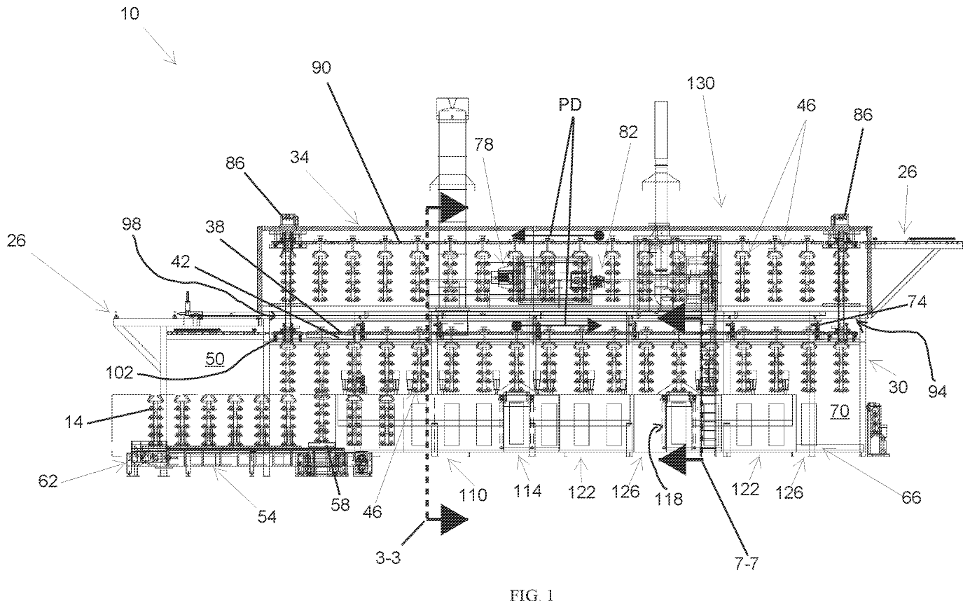

FIG. 1 illustrates a system 10 for coating a product 14 through a product coating method. Specifically, the method includes coating an interior or inner surface 18 and an exterior or outer surface 22 of the product 14 or “pipe” 14. In the illustrated embodiment, the method includes coating the interior and exterior surfaces 18, 22 of the pipe 14 simultaneously with an electro-coating or “e-coat,” in which the pipe 14 is conducted with electricity to drive coating deposition onto the pipe 14. In another embodiment by way of example, the interior surface 18 and exterior surface 22 may be coated at different times and/or with different coatings.

It should be noted that while the below description is made with respect to pipes, the system 10 and method can be used to coat any product 14 having an internal cavity that may be difficult or impossible to effectively and economically coat using conventional methods. Likewise, while the below description is made with respect to coating the interior surface 18 of the product 14 with an electrodeposition or e-coat method, other types of coating applications may be used for the interior surfaces 18. For example, the interior surface 18 of the product 14 may be coated using powder coating, auto deposition, and other product coating systems and methods. Furthermore, while computer automated processes are well known, it should be noted that the below description is made with respect to a hybrid process including automated and human-conducted tasks, but could be fully automated or fully human-conducted based on design preferences and/or monetary considerations.

With reference to FIGS. 1-3, the system 10 includes a frame 26 supporting an e-coat finishing line 30 and a curing oven 34. The finishing line 30 includes a process track 38 and a stationary track 42 supported on the frame 26 for selectively holding a plurality of product racks 46. The product racks 46, which may be pushed along the process track 38, support a plurality of the pipes 14. A first end 50 of the finishing line 30 has a loading zone 54 where the product rack 46 may be placed in a skid 58 and loaded on to the process track 38 via a load conveyor 62. After the racks 46 are moved from the skid 58 to the process track 38, the racks 46 continue on the process track 38 along a process direction PD. The skid 58 continues along the load conveyor 62 and returns on the load conveyer 62 to receive another rack 46, for example. Vats 66 or “tanks” 66 are provided along the finishing line 30 below the process track 38 and the stationary track 42 between the first end 50 and a second end 70. Stated another way, the process track 38 and the stationary track 42 extend between the first and second ends 50, 70 of the finishing line 30 above the tanks 66.

The frame 26 further supports a plurality of yokes 74 along the frame 26 to assist in driving the product rack 46 along the process track 38. Once the product racks 46 have been loaded onto the process track 38, the product racks 46 may be advanced along the process track 38 under influence from the yoke 74 in combination with the force of the load conveyer 62 loading a new product rack 46 onto the process track 38. In another embodiment by way of example, advancement of the product racks 46 along the tracks 38, 42 may be continuously driven by a motor 78 in communication with a programmable logic controller (PLC) 82 or other suitable controlling device. In still another embodiment by way of example, advancement of the product racks 46 along the tracks 38, 42 may be driven solely by a pushing force on a single or select number of product racks 46 in a series of product racks 46 on the tracks 38, 42. Once the product racks 46 are loaded on the tracks 38, 42, the product racks 46 are then advanced selectively through the tanks 66, and into the oven 34 at the second end 70 of the finishing line 30. In the illustrated embodiment, rack actuators 86 are supported on the frame 26 at the first end 50 and the second end 70 for carrying the product racks 46 from the process and stationary tracks 38, 42 to an oven track 90, or vice versa. The oven track 90 is supported on the frame 26 within the curing oven 34. The rack actuators 86 are supported, respectively, at an oven entrance 94 located at the second end 70 and at an oven exit 98 located near the loading zone 54 at the first end 50.

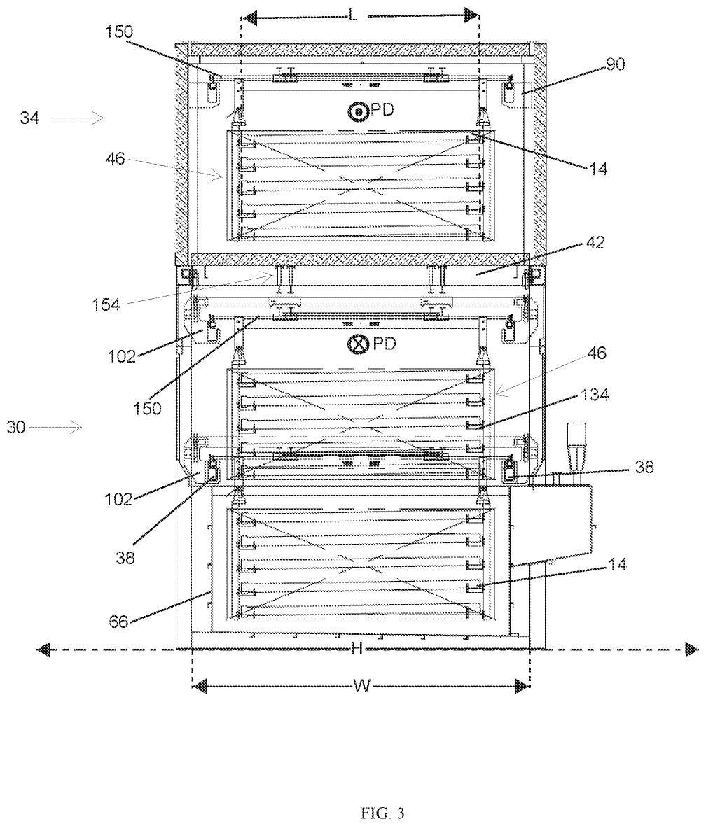

FIG. 1 further illustrates the frame 26 supporting track actuators 102 that moveably support the process track 38 on the frame 26 for raising and lowering the process track 38 relative to the frame 26. FIG. 3 illustrates the process track 38 in a lowered position and further illustrates an example position of a product rack 46 if the process track 38 were in a raised position. The process track 38 is moveable between the raised and lowered positions by the track actuators 102. In the illustrated embodiment, the stationary track 42 may be rigidly supported by the frame 26 and not moveable relative to the frame 26. In another embodiment by way of example, the process track 38 extends continuously along the finishing line 30 in the process direction PD and forms a complete path, and rack actuators are not provided. Along the complete path, the process track 38 extends through the entrance 94 to the oven 34 at the second end 70 and through the exit 98 from the oven 34 at the first end 50. In such an example embodiment, the process track 38 and oven track 90 may be formed as a single track Stated another way, the example process track 38 is configured to support movement of the product racks 46 in a full loop or cycle sequentially through the finishing line 30 and the oven 34 in the process direction PD. Although FIGS. 1-3 illustrate the oven 34 located vertically above the finishing line 30, it should be noted that the oven 34 may be located next to, below, or in location spaced away from the finishing line 30.

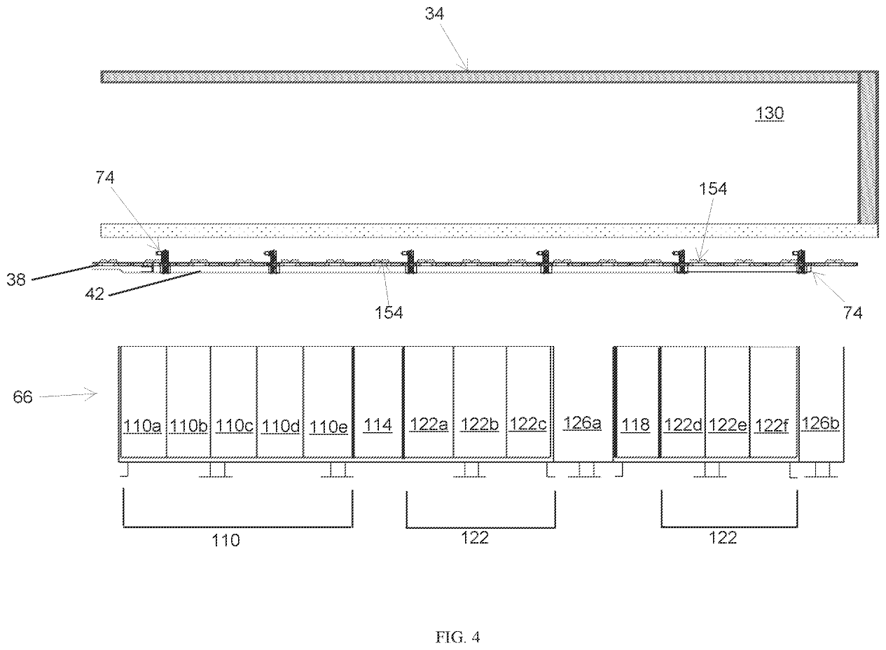

With reference to FIGS. 3-6, the illustrated system 10 and method of coating the pipe 14 includes a multi-phase coating process made up of multiple stations at least partially provided in the tanks 66. The multi-phase process includes, as illustrated in FIG. 4, pre-treatment phases 110, a cathodic e-coat phase 114, one or more rinse phases 122, dripping phases 126a, 126b, an anodic e-coat phase 118, and a curing phase 130. As described in further detail below, some of the phases of the process can be repeated or, in other words, used more than one time during processing of a product(s) 14. The pre-treatment phases 110 may include a first immersion rinse phase 110a, a fist immersion conditioner phase 110b, a first immersion zinc phosphorus phase 110c, a second immersion rinse phase 110d, and a third immersion rinse phase 110e. The cathodic e-coat phase 114 of the finishing line 30 may be located to the right of the pre-treatment phases 110, as illustrated from left to right in FIG. 4. First, second, and third immersion post rinse phases 122a, 122b, 122c may follow to the right of the cathodic e-coat phase 114. A first drip phase 126a may be provided to the right of the first, second, and third immersion post rinse phases 122a, 122b, 122c. The anodic e-coat phase 118 of the finishing line 30 may be located to the right of the first drip phase 126a. Fourth, fifth, and sixth immersion post rinse phases 122d, 122e, 122f may follow to the right of the anodic e-coat phase 118. A second drip phase 122b may follow to the right of the fourth, fifth, and sixth immersion post rinse phases 122d, 122e, 122f. In another embodiment by way of example, some of the phases described above may be omitted. For example, the first, second, and third immersion post rinse phases 122a, 122b, 122c may be combined into a single post rinse phase 122. It should be understood that each of the phases takes place at/in respective stations in the tank. For example, the first immersion rinse phase 110a takes place in a first immersion post rinse station 110a, the cathodic e-coat phase 114 takes place in a cathodic e-coat station 114, etc. It should also be understood that the phases/stations have been described above in physical relation to one another and the overall system, but the above description does not limit an order for which the phases/stations occur during the multi-phase process.

Referring now to FIGS. 3-6, the product rack 46 includes product support members 134 arranged on the rack 46 to support a variety of pipes. The product support members 134 are arranged to hold a plurality of pipes 14 having a diameter D and a length L. The length L of pipe 14, measured along a linear axis between two ends of the pipe 14, may be any length that fits within a width W of the plurality of stations. In the illustrated embodiment, the pipes 14 all have similar or equal diameters D and lengths L. In another embodiment by way of example, the product support members 134 can support pipes 14 having different diameters D and lengths L. As specifically illustrated in FIG. 3, the pipes 14 are supported on the product racks 46 in a non-horizontal orientation, which may increase fluid flow into a hollow part 138 of the pipe 14 (i.e., an area defined by at least a portion of the interior surface) and drainage from the hollow part 138. The non-horizontal orientation also allows air bubbles to rise and escape from the coating material to ensure equal and complete coverage of the coating on the pipe 14. In the illustrated embodiment, the pipes 14 are held on the product racks 46 such that the linear axis of the pipe 14 along which the length L is measured is offset from the horizontal plane H by an angle of approximately 8 degrees. In another embodiment by way of example, the pipes 14 may be supported on the product racks 46 such that the linear axis of the pipe 14 along which the length L is measured is offset from the horizontal plane H between an angle greater than 0 degrees and 90 degrees. In yet another embodiment by way of example, the pipes 14 may be supported on the product racks 46 such that the linear axis of the pipe 14 along which the length L is measured is offset from the horizontal plane H between an angle greater than 0 degrees and 20 degrees. In still another embodiment by way of example, the pipes 14 may be supported on the product racks 46 such that the linear axis of the pipe 14 along which the length L is measured is offset from the horizontal plane H between an angle greater than 0 degrees and 10 degrees.

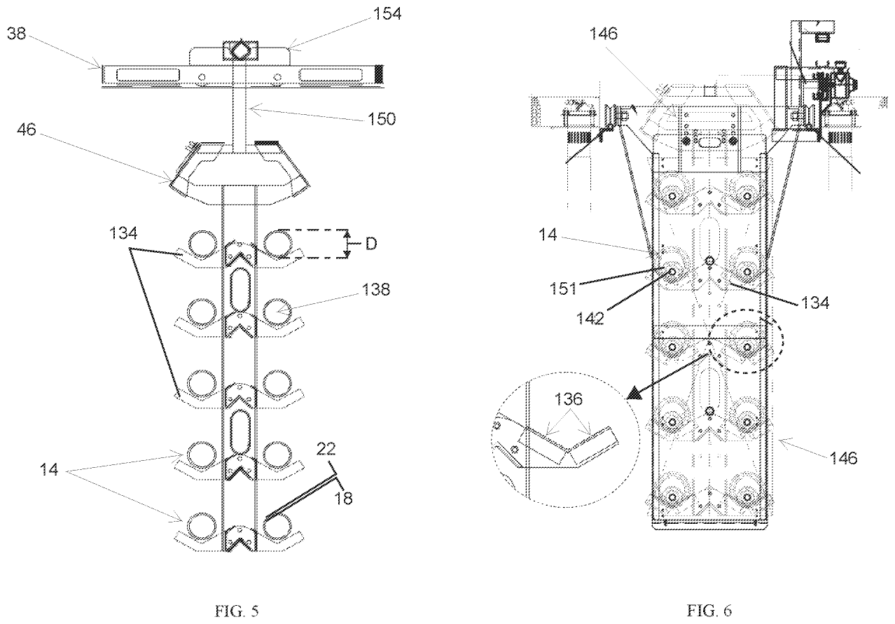

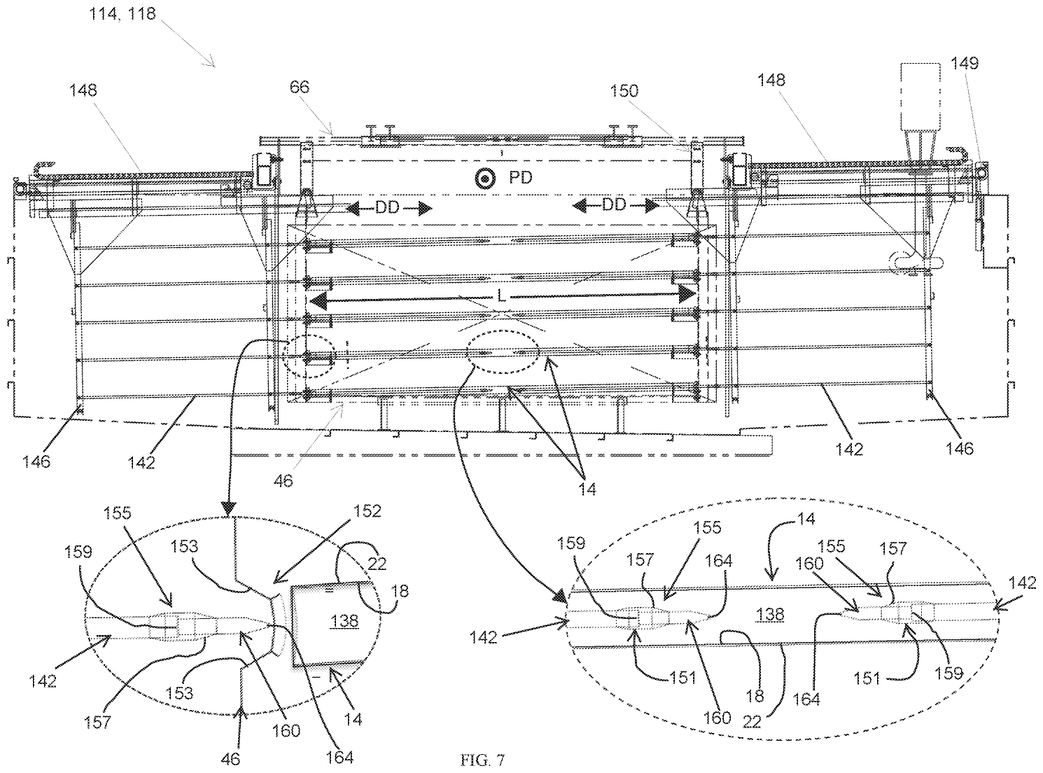

The product support members 134 arranged on the rack 46 include conducting teeth 136 (FIG. 6). The teeth 136 provide an electrically conductive support surface between the rack 46 and the pipe 14 supported on the rack 46. The teeth 136 are formed as alternating peaks and valleys to provide a sawtooth configuration that allows for the variety of pipes to be supported and maintained on the product support members 134. The peak of each of the teeth 136 is formed as a fine, blade-like line that provides minimal surface contact between the teeth 136 and the pipe 14. During product coating, electricity may be conducted through the rack 46, through the conductive line surface provided by the teeth 136, and into the pipe 14 on the rack 46 to ensure that the pipe 14 is evenly and completely coated. It should be understood that the blade-like conductive line will be as thin as practical to minimize an area of the support surface between the teeth 136 and the pipe 14 while still maintaining support of the pipe 14 on the rack 46.

The pipes 14 may be loaded onto the support members 134 prior to loading the product racks 46 onto the load conveyor 62, or at another time before the product rack 46 proceeds to the first immersion rinse phase 110a along the process track 38. Once the pipes 14 have been loaded onto the product support members 134, the product rack 46 loaded with pipes 14 may proceed to the first immersion rinse phase 110a, in which the process track 38 may be lowered to immerse the product rack 46 in an unheated rinsing solution that may be pump-agitated within the first immersion rinse station 110a. Once the product rack 46 undergoes the first immersion rinse phase 110a, the entire process track 38 may be elevated to remove the product rack 46 from the first immersion rinse phase 110a. Next, another product rack 46 may be loaded on to the process track 38 at the loading zone 54, which pushes all of the product racks 46 on the process track 38 ahead a phase. The product rack 46 may then proceed to the first immersion conditioner phase 110b in a similar manner, in which the process track 38 is lowered to immerse the product rack 46 in an unheated conditioner solution that may be pump agitated within the first immersion conditioner station 110b. Next, as another product rack 46 is added onto the process track 38, each product rack 46 on the process track 38 advances along the process direction PD. The product rack 46 then proceeds to the first immersion zinc phosphorus phase 110c, in which the process track 38 is lowered to immerse the product rack 46 in a zinc phosphate solution heated at approximately 130 degrees Fahrenheit and pump agitated within the first immersion zinc phosphorus station 110c at a maximum agitation. Once the product rack 46 completes the first immersion zinc phosphorus phase 110c, the product rack 46 advances on the process track 38 through the second and third immersion rinse phases 110d, 110e that are each generally the same as the first immersion rinse phase 110a but provided in their respective stations.

Upon completion of the second and third immersion rinse phases 110d, 110e, the pipes 14 on the product racks 46 are suited to proceed to either of the cathodic e-coat and anodic e-coat phases 114, 118, depending on whether the pipes 14 require a first e-coat (e.g., cathodic e-coat) or a second e-coat (e.g., anodic e-coat). In the cathodic e-coat phase 114, the process track 38 may be lowered to immerse the product rack 46 in a first electrocoating liquid chilled at approximately 90 degrees Fahrenheit in the cathodic e-coat station 114. The first electrocoating liquid within the cathodic e-coat station 114 is then charged with electric current for a prescribed duration (e.g., about 120 seconds) to drive the deposition of coating material on to the pipes 14. In theoretical terms, the pipe 14 acts as a cathode in an electrolysis equation, hence the term “cathodic e-coat.” As electric current flows, charged ions in the first electrocoating liquid gain electrons at the inner surface 18 and the outer or surface 22 of the pipe 14 and transform into a coating on the pipe 14. In the cathodic e-coat phase 114, the first electrocoating liquid may be a positively charged acidic liquid that is flushable from the cathodic e-coat phase 114 periodically throughout the coating process. As described in greater detail below, electrodes 142 supported on an electrode rack 146 may be inserted within the interior surface 18 of the pipe 14 during the cathodic e-coat phase 114. This increases the current flow and current flow density within the pipe 14 and therefore increases an amount and/or quality of coating on the interior surface 18 of the pipe 14.

Following the cathodic e-coat phase 114, the process track 38 may be selectively lowered to accommodate moving the product racks 46 along the process direction PD through the first, second, and third immersion post rinse phases 122. The first and second immersion post rinse phases 122 include mixer agitation of respective post rinse solutions. The first, second, and third immersion post rinse phases 122a, 122b, 122c include pump agitation of a respective post rinse solution. After the first, second, and third immersion post rinse phases 122a, 122b, 122c, the product racks 46 proceed to the first drip phase 126a, where the product racks 46 are allowed to drip in the first drip station 126a for any suitable pre-determined interval of time.

With specific reference to FIG. 3, the illustrated stationary track 42 will now be described in greater detail. As stated above, the stationary track 42 is rigidly supported on the frame 26 meaning that the stationary track 42 is not moved by the track actuators 102. The product racks 46 may each be supported on a load bar 150 which is selectively coupled to either the process track 38 or the stationary track 42. The stationary track 42 includes a series of hold-ups 154 for shuttling the load bar 150 of each product rack 46 between the stationary track 42 and the process track 38. For example, the load bar 150 supporting the product rack 46 attached to the process track 38 above the first drip station 126a may be transferred to the stationary track 42 such that the product rack 46 is not lowered with the other product racks 46 supported on the process track 38. In a similar manner, the load bar 150 of each product rack 46 may be transferred to the rack actuators 86 for movement between the process and stationary tracks 38, 42 and the oven track 90.

Referring now to FIG. 4, once the first drip phase 126a is complete, the product racks 46 proceed to a series of hold-ups 154 above the anodic e-coat phase 118, the fourth, fifth, and sixth immersion post rinse phases 122d, 122e, 122f, and the second drip phase 126a. After the product rack 46 is held up over the second drip phase 126a, the load bar 150 of the product rack 46 may be transferred to the rack actuator 86 and then transferred to the oven track 90. The product rack 46 on the oven track 90 continues to “step” through the curing oven 34 each time a new product rack 46 is added to the oven track 90. Once the product rack 46 reaches the oven exit 98, the product rack 46 may be unloaded or transferred back to the process track 38.

Still referring to FIG. 4, each product rack 46 travels through a first rack path and a second rack path. The first rack path, as described above, includes the product rack 46 proceeding through the immersion pre-treatment phases 110, the cathodic e-coat phase 114, the first, second, and third immersion post rinse phases 122a, 122b, 122c, the first drip phase 126a, and the curing phase 130. The product racks 46 proceeding through the first rack path are held up on a first part of the hold-ups 154 supported on the stationary track 42 above the anodic e-coat station 118, the fourth, fifth, and sixth immersion post rinse stations 112d, 122e, 122f, and the second drip station 126b. The second rack path includes the product racks 46 proceeding through the immersion pre-treatment phases 110, the anodic e-coat phase 118, the fourth, fifth, and sixth immersion post rinse phases 122d, 122e, 122f, the second drip phase 126b, and the curing phase 130. The product racks 46 proceeding through the second rack path are held up on a second part of the hold-ups 154 supported on the stationary track 42 above the cathodic e-coat station 114, the first, second, and third immersion post rinse stations 122a, 122b, 122c, and the first drip station 126a. It should be understood that the product racks 46 on the hold-ups 154 still continue to advance along the process direction PD as new product racks 46 are added to the process track 38. Stated another way, provided that none of the product racks 46 are missing, a product rack 46 will be present in each phase/station, and whether or not that product rack 46 is held up or lowered with the process track 38 depends on which of the rack paths that product rack 46 is on.

The second rack path will now be described in greater detail with reference to FIG. 4. Once the pipes 14 on the product rack 46 have proceeded through each phase in the first rack path, the pipes 14 are now completely cathodic e-coated and the product rack 46 may proceed from the exit 98 of the curing oven 34 to the process track 38, thereby starting on the second rack path to be anodic e-coated over top of the cathodic e-coat layer. The second rack path effectively skips the cathodic e-coat phase 114 and the immersion pre-treatment phases 110 of the first rack path. Once on the second rack path, the product racks 46 proceed to the anodic e-coat phase 118, in which the product rack 46 is immersed in a second electrocoating liquid chilled at approximately 72 degrees Fahrenheit in the anodic e-coat station 118. The second electrocoating liquid within the anodic e-coat station 118 is then charged with electric current for a prescribed duration (e.g., about 120 seconds) to drive the deposition of a secondary coating on the pipe 14. In theoretical terms, during the anodic e-coat phase 118, the cathodic e-coated pipe 14 acts as an anode in an electrolysis equation, hence the term “anodic e-coat.” The second electrocoating liquid may be negatively charged alkaline based bath that may be flushed less often than the acidic first electrocoating liquid. As electric current flows, the second electrocoating liquid forms an anodic e-coat on the cured cathodic e-coat previously applied to the inner and outer surfaces 18, 22 of the pipe 14. Similarly to the cathodic e-coat phase 114, the electrodes 142 supported on the electrode rack 146 may be inserted within the interior surface 18 of the pipe 14 during the anodic e-coat phase 118 to better regulate the electric current flow and density of current flow within the pipe 14. The amount of current density is specifically regulated during the cathodic and anodic e-coat phases 114, 118 to ensure the specification of each coating (e.g., amounts of oxidation, anodic/cathodic deposition, etc.).

The anodic e-coat or “anodized layer” improves the hardness, wear resistance, electrical insulation, etc. of the pipe 14. The porous surface of the anodized layer may be sealed during the fourth, fifth, and sixth immersion post rinse phases 122d, 122e, 122f, which sequentially follow the anodic e-coat phase 118 along the process direction PD. The fourth and fifth immersion post rinse phases 122d, 122e include mixer agitation of respective post rinse solutions. The fourth, fifth, and sixth immersion post rinse phases 122d, 122e, 122f include pump agitation of a respective post rinse solution. After the sixth immersion post rinse phase 122f, the product racks 46 may proceed to the second drip phase 126b, where the product racks 46 can drip in the second drip station 126b for any suitable pre-determined interval of time.

In both of the first and second rack paths, following the respective drip stations 126, the product racks 46 may proceed through the oven 34, along the oven track 90, while being heated at approximately 450 degrees Fahrenheit. Once the curing process 130 is complete, the product racks 46 may be transported by the rack actuators 86 either to be unloaded from the finishing line 30 (upon completion of the second rack path) or back to the process track 38 (upon completion of the first rack path). Alternatively, as stated above by way of example, the rack actuators 86 may be omitted such that the product racks 46 may be continuously transported on the alternate process track 38 through the first and second rack paths.

With reference to FIGS. 6 and 7, the electrodes 142 supported on the electrode rack 146 and their function will now be described in greater detail. The electrode racks 146 are provided in each of the cathodic and anodic e-coat stations 114, 118 for selectively inserting the respective electrodes 142 into the hollow part 138 of each pipe 14. The electrode racks 146 may be extendable in a direction DD parallel to/along the length L of the pipes 14 supported on the product support members 134. In some embodiments, the electrodes 142 are manufactured from stainless steel (e.g., 304 grade), which may have a current density of about 7.5 to 8.5 g/cm³. In another embodiment by way of example, each electrode 142 is manufactured from a precious metal or another conductive material that has a current density different from than that of stainless steel (e.g., tungsten at approximately 19.3 g/cm³, aluminum at approximately 2.7 g/cm³, etc.).

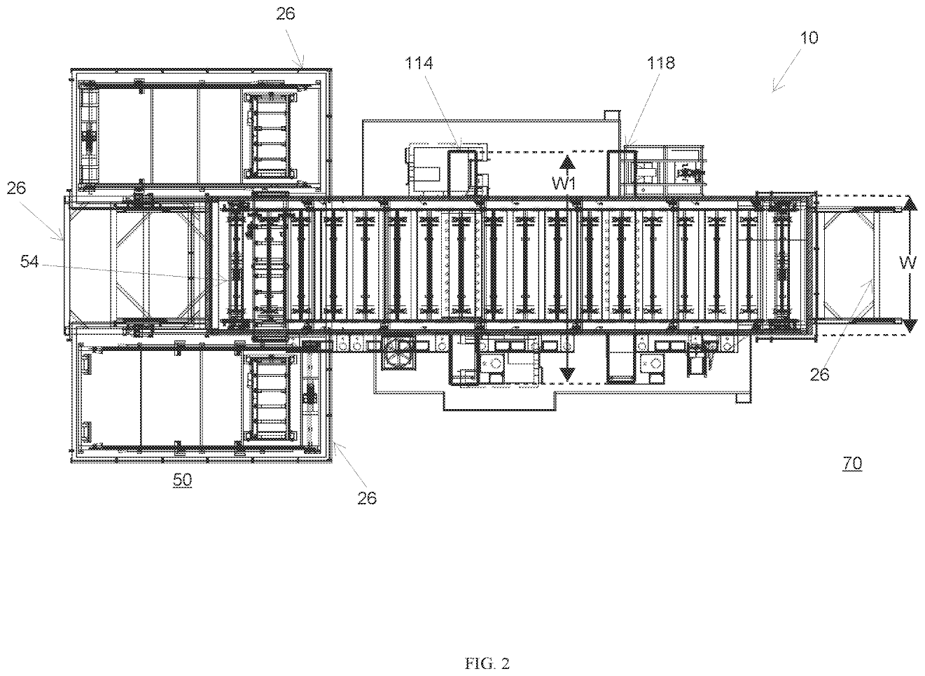

Referring now to FIGS. 6 and 7, the electrode rack 146 supports the electrodes 142 in an arrangement that is complementary to the arrangement of pipes 14 on the product rack 46. In the illustrated embodiment of FIG. 7, the electrode racks 146 are supported on the tanks 66 of the cathodic and anodic e-coat stations 114, 118 to be inserted into and retracted from the pipes 14. The cathodic and anodic e-coat stations 114, 118 may have a width W1 (FIG. 2) that is wider than the width W of the other stations and wider than the length L of the pipes 14 to accommodate full removal of the electrodes 142 from within the pipes 14. Just as the product racks 46 can support pipes 14 having different diameters D and lengths L, another example embodiment of the electrode rack 146 can support electrodes 142 of different diameters and lengths. In the illustrated embodiment, the diameter D of each pipe 14 may be less than or equal to 6 inches, while a diameter of each electrode 142 may be less than or equal to 1 ½ inches. In one example construction, according to the illustrated embodiment, the diameter D of the pipe 14 is 2 inches, and a diameter of the electrode 142 is ⅜ inches.

As will be described further below, FIG. 7 illustrates the electrode rack 146 and electrodes 142 in a first or “inserted” position in which one or more of the electrodes 142 are at least partially inserted into the hollow part 138 of one or more respective pipes 14, and a second or “retracted” position in which the electrodes 142 may be retracted from pipes 14. As best illustrated in FIG. 7, the electrode rack 146 may be operated to move between the first and second positions along the direction DD and across the process direction PD (i.e., at least partially transverse to the process direction PD) to selectively insert one or more electrode 142 into the hollow part 138 of the one or more respective pipe 14 held on the product rack 46. In the inserted positioned, the electrodes 142 may be extended along and overlapping with the product support members 134 to fit within the hollow part 138. In the retracted position, the electrodes 142 may be retracted away from the product support members 134 to be removed from the hollow part 138.

In another embodiment by way of example, the electrode rack 146 can be offset to any direction to accommodate the length L of each pipe. For example, the pipes 14 may be supported on the product rack 46 with one end of the pipe 14 farther forward in the process direction PD than another end of the pipe 14. In such example embodiment, the electrode rack 146 may be aligned in a corresponding orientation. Stated another way, the electrode rack 146 and product rack 46 are formed to nest or physically mesh with one another such that each of the electrodes 142 may be fully inserted into one of the pipes 14 during the cathodic and anodic e-coat phases 114, 118. In yet another embodiment by way of example, the electrode rack 146 may be mounted on the process track 38 and moveable with the process track 38 between the raised and lowered positions by the track actuators 102. In such example, the electrode rack 146 is moveable between the lowered and raised positions and is operable to insert the electrodes 142 into the pipes 14 prior to being lowered into the corresponding e-coat phase 114, 118. Disassociating the electrode racks 146 from the structure of the tank 66 and retracting the electrodes 142 while above the tank 66 may allow for the width W1 of the cathodic and anodic e-coat phases 114, 118 to be reduced.

The electrode rack 146 is attached to chain drive mechanisms 148, which are driven by a motor 149, to move the electrodes 142 and the electrode rack 146 in the direction DD. In some embodiments, the motor 149 is driven by compressed air in order to minimize additional electrical components, but other types of motors and driving mechanisms (e.g., hydraulic motors, electric motors, etc.) are contemplated and could be suitable. For example, the compressed air motor 149 could be supplemented or replaced by an electric motor as long as electrical charge produced by the electric motor is isolated from other electrical components (i.e., electrodes 142, cathodic and anodic e-coat stations 114, 118) in the coating process within the coating system 10. The chain drive mechanism 148 may be further operated to completely remove the electrode racks 146 from either of the e-coat stations 114, 118 to facilitate easier maintenance and/or cleaning of the e-coat stations 114, 118 and electrode racks 146.

As further illustrated in FIG. 7, the electrodes 142 are held relative to the pipes 14 such that electrodes 142 do not contact the inner surface 18 of the pipe 14 when inserted into the hollow part 138. The product rack 46 further includes a guiding member, such as a guiding cone or funnel 152 attached thereon for moveably supporting the electrodes 142 on the electrode rack 146 as the electrodes 142 are moved (e.g., inserted) into the pipes 14. As further shown in FIG. 7, the pipes 14 are positioned adjacent the guiding funnel 152 such that electrodes 142 passing through the guiding funnels 152 substantially immediately extend into the pipes 14. The guiding funnels 152 thereby ensure that each electrode 142 aligns with the corresponding hollow part 138 during operation/movement of the electrode rack 146. Stated another way, the electrode racks 146 are configured to be driven by the drive mechanism 148 and motor 149, and the electrodes 142 are adjusted or aligned by the guiding funnels 152. The guiding funnel 152 may include walls 153 forming a generally tapered or funneled cross section configured to produce a smoother and accurate insertion/retraction of the electrodes 142 into and out of the hollow part 138 of the pipe 14. A portion of the guiding funnel 152 may also extend from the product rack 46 and at least partially into a portion of the pipe 14. In some embodiments by way of example, the guiding funnel 152 is integrally formed on the product rack 46.

Each electrode 142 may include or be partially surrounded/encased by insulating material 151 to further prevent direct contact between the electrode 142 and the pipe 14. The insulation material 151 also prevents the electrodes 142 from receiving undesired coating and protects the electrodes 142 against scratching and/or wear. In the illustrated embodiment, the insulating material 151 is a high heat resistant material (i.e., Teflon) but other insulating materials are contemplated (e.g., high heat resistant polymers and plastics, ceramics, etc.). The insulating material 151 is additionally electrically insulating so as to prevent electrical conduction between uninsulated portions of the electrodes 142 and pipes 14.

As best illustrated in FIG. 7, a terminating end 159 of each electrode 142 may include a tip 160 having a tapering cross-section that transitions to an end point 164. The end point 164 further accommodates proper fitting/relative alignment between the electrodes 142 and the pipes 14. The tip 160 is not electrically insulated and can be utilized as a conductor or electrode. The insulating material 151 may be primarily provided on an end cap 155, and the end cap 155 may be removably coupled adjacent the terminating end 159 of the electrodes 142. The cap 155 may include one or more tapered/slanted insulated surfaces 157 that are complementary to the tapering walls 153 of the funnel 152.

Additionally, the walls 153 of the funnel 152 may include electrically insulating material such that, during insertion of the electrodes 142 through the funnel 152 and into the pipe 14, the insulating material 151 of the electrodes 142 may contact the electrically insulated walls 153 without conducting electricity/charge between the electrodes 142 and the product rack 46. Stated another way, the walls 152 and insulating material 151 provide an electrically non-conductive barrier between the funnel 152/product rack 46 and at least an uninsulated portion of the electrodes 142. As such, the pipe 14 does not physically contact uninsulated portions the electrode 142. Rather, the pipe 14 is in fluid communication with the electrode 142 through the electrocoating liquid. The electric current provided in the e-coating phases 114, 118 flows through the contactless fluid engagement between the electrodes 142 and the pipes 14 and therefore at least partially drives the deposition of the coating on the pipes 14.

The insulating material 151 also prevents the electrodes 142 in the anodic e-coat station 118 from contacting any structure portion of the frame 26 (i.e., finishing line 30, curing oven 34, etc.). The electrode racks 146 in the anodic e-coat station 118 are also isolated from other structure portions of the frame 26. The electrodes 142 and electrode racks 146 in the anodic e-coat station 118 are oppositely charged from the rest of the conductive components, particularly the pipe 14 and product racks 46. Contact and/or close contact arcing between a charged electrode 142 in the anodic e-coat station 118 and a portion of the frame 26 could cause a short circuit or “dead short” and fault/damage the system 10.

Shorts and/or close contact arcing are detected by the PLC 82, which monitors an output amperage for several seconds at the beginning of each of the e-coat stations 114, 118 and determines if a short/arc occurred. The PLC 82 may interpret the output amperage data and alter the coating process if a large enough short is detected. It should be understood that any oppositely charged components in the system 10 that could cause a potential dead short are isolated from one another by isolation/insulation material and/or physical distance. For example, components present in the anodic e-coat station 118 are isolated from components not present in the anodic e-coat station 118. Such oppositely charged components could include mating surfaces, fasteners, mounting parts, etc.

With continued reference to FIG. 7, the electrodes 142 on the electrode rack 146 may be moved between a first or inserted position and a second or retracted position. In the first position, at least one electrode 142 fits into the hollow part 138 of at least one of the pipes 14 in order to function as described above. In the second position, the electrodes 142 do not fully extend into hollow part 138 of the pipes 14. It should be understood that the electrode 142 could be less than fully extended into the hollow part 138 of the pipe 14 to help drive the e-coating process. In the illustrated embodiment, the electrode 142 may assist in driving the e-coating process while being inserted into less than 10% of the length L of the pipe 14. In another embodiment by way of example, the electrode 142 can be inserted into less than 25% of the length L of the pipe 14. In yet another embodiment by way of example, the electrode 142 can be inserted into less than 50% of the length L of the pipe 14. In even another embodiment by way of example, the electrode 142 can be inserted into less than 75% of the length L of the pipe 14. In still another embodiment by way of example, the electrode 142 can be inserted into less than 100% of the length L of the pipe 14. In the illustrated embodiment, as shown in FIG. 7, one or more of the electrodes 142 may be fully inserted or extended into the complementary one or more pipes 14. In one example in which the electrodes 142 are each fully extended into the pipes 14, the end points 164 of electrodes 142 on opposite sides of the frame 26 may be approximately 10 inches away from one another along the direction DD.

Although the invention has been described in detail with reference to certain preferred embodiments, variations and modifications exist within the scope and spirit of one or more independent aspects of the invention as described. For example, although the invention has been described as including a single process track 38, stationary track 42, and oven track 90, it should be understood that any number of tracks 38, 42, 90 are contemplated. Such example applies to any supporting mechanisms discussed herein that may be dependent on the number of tracks 38, 42, 90 provided (e.g., number of tanks 66 provided, number of curing ovens 34 provided, etc.).

What is claimed is:

1. A product coating system comprising:
a first end, a second end, and a frame extending between the first end and the second end;
a pre-coating treatment station disposed between the first end and the second end;
a first e-coat station disposed between the pre-coating treatment station and the second end;
a second e-coat station disposed between the pre-coating treatment station and the second end;
a curing station including an oven having an entrance and an exit;
a process track supported on a portion of the frame and selectively moveable between a lowered position and a raised position, the process track extending above the pre-coating treatment station, the first e-coat station, and the second e-coat station;
an oven track extending through the oven;
a rack configured to carry one or more products, the rack selectively moveable along the process track and the oven track and moveable with the process track to the lowered position, in which the rack is positioned within one of the pre-coating treatment station, the first e-coat station, and the second e-coat station;
a first hold up inhibiting the rack from being lowered into the second e-coat station;
a second hold up inhibiting the rack from being lowered into the first e-coat station;
a first rack path including the pre-coating treatment station, the first e-coat station, the first hold up, and the curing station; and
a second rack path including the pre-coating treatment station, the second hold up, the second e-coat station, and the curing station;
wherein the rack is sequentially moveable through the first rack path and the second rack path.

2. The product coating system of claim 1, further comprising a plurality of yokes supported by the frame, wherein the rack is configured to be loaded on to the process track via a load conveyor.

3. The product coating system of claim 2, wherein the rack is a first rack in a plurality of racks each configured to be loaded on to the process track, and wherein each rack in the plurality of racks is configured to be advanced along the process track by the plurality of yokes and the load conveyor.

4. The product coating system of claim 2, wherein the rack is a first rack in a plurality of racks each configured to be loaded on to the process track, and wherein each rack in the plurality of racks is configured to be advanced along the process track by a motor in communication with a controller.

5. The product coating system of claim 1, further comprising a stationary track supported on a portion of the frame and configured to remain stationary relative to the process track, wherein the rack is a first rack in a plurality of racks each supported on a load bar in a plurality of load bars selectively coupled to the process track or the stationary track.

6. The product coating system of claim 5, wherein the stationary track includes the first hold up and the second hold up, each of the first hold up and the second hold up including a shuttle configured to transfer the plurality of load bars between the stationary track and the process track,
wherein the first hold up holds a first load bar moving through the second rack path over the first e-coat station and inhibits the first load bar from being lowered into the first e-coat station, and
wherein the second hold up holds a second load bar moving through the first rack path over the second e-coat station and inhibits the second load bar from being lowered into the second e-coat station.

7. The product coating system of claim 6, wherein the frame supports actuators at the first end and the second end, the actuators being configured to transfer the load bar between the oven track and either the process track or the stationary track.

8. The product coating system of claim 1, further comprising a plurality of electrodes supported on a first electrode rack moveably supported on a first tank positioned in the first e-coat station, the plurality of electrodes being selectively insertable into and retractable from the one or more products carried on the rack.

9. The product coating system of claim 8, further comprising a plurality of electrodes supported on a second electrode rack moveably supported on a second tank positioned in the second e-coat station, the first e-coat station includes one of a cathodic e-coat station and an anodic e-coat station, and the second e-coat station includes the other one of the cathodic e-coat station and the anodic e-coat station,
wherein the cathodic e-coat station and the anodic e-coat station are aligned along a process direction, such that the rack proceeds through the entire first rack path before proceeding to the second rack path.

10. A method for coating a product comprising:
providing a frame having a first end and a second end;
supporting a process track on a portion of the frame;
extending the process track above a product pre-coating treatment station, a first product e-coat station, and a second product e-coat station,
wherein the product pre-coating treatment station is disposed between the first end and the second end,
wherein the first product e-coat station is disposed between the product pre-coating treatment station and the second end, and
wherein the second product e-coat station is disposed between the product pre-coating treatment station and the second end;
selectively moving the process track between a lowered position and a raised position;
supporting an oven track on a portion of the frame;
extending the oven track through a e-coat cure oven defining a curing station, the cure oven including an entrance and an exit;
removably supporting a rack for carrying one or more products on the process track and the oven track;
selectively moving the rack along the process track and along the oven track through a first rack path and a second rack path,
wherein when the process track is in the lowered position, the rack supported on the process track is lowered into one of the product pre-coating treatment station, first product e-coat station, and the second product e-coat station,
wherein the first rack path includes the product pre-coating treatment station, the first product e-coat station, a first series of hold ups supported on the frame above the second product e-coat station configured to prevent the rack from being lowered with the process track, and the curing station, and
wherein the second rack path includes the product pre-coating treatment station, a second series of hold ups supported on the frame above the first product e-coat station configured to prevent the rack from being lowered with the process track, the second product e-coat station, and the curing station; and
sequentially moving the rack through the first rack path and the second rack path.

11. The method for coating a product of claim 10, further comprising loading the rack onto the process track via a load conveyor.

12. The method for coating a product of claim 10, further comprising transferring the rack between the process track and the oven track through use of a first actuator and a second actuator.

13. The method for coating a product of claim 12, further comprising positioning the first actuator at the entrance of the cure oven; and
positioning the second actuator and the exit of the cure oven.

14. The method for coating a product of claim 10, further comprising supporting a plurality of electrodes on an electrode rack, the plurality of electrodes being selectively insertable into and retractable from the one or more products carried on the rack.

15. The method for coating a product of claim 14, further comprising moveably supporting the electrode rack on a first tank positioned in the first product e-coat station;
moveably supporting the electrode rack on a second tank positioned in the second product e-coat station;
dual coating the one or more products carried on the rack by proceeding the rack through the entire first rack path before proceeding the rack through the second rack path.

16. An e-coat line comprising:
a frame supporting a process track configured to extend along a process direction;
a workpiece rack moveably supported on the frame, the rack including support members configured to hold a plurality of hollow workpieces in a predetermined arrangement, the workpiece rack moveable relative to the frame between a raised position and a lowered position; and
a plurality of electrodes supported on an electrode rack in a predetermined arrangement complementary to the predetermined arrangement of the plurality of hollow workpieces on the support members, the electrode rack moveable relative to the workpiece rack in a direction crossing the process direction between
a first position, in which the plurality of electrodes are extended along and overlapping with the support members to fit within the plurality of hollow workpieces, and
a second position, in which the plurality of electrodes are retracted away from the support members to be removed from the plurality of hollow workpieces.

17. The e-coat line of claim 16, wherein the plurality of electrodes are moveable to the first position while the workpiece rack is supported in the raised position.

18. The e-coat line of claim 16, wherein the workpiece rack includes one or more guiding members configured to align the plurality of electrodes within the plurality of hollow workpieces.

19. The e-coat line of claim 18, wherein each of the plurality of electrodes includes a tip configured to align the plurality of electrodes with each of the one or more guiding members.

20. The e-coat line of claim 19, wherein the guiding member includes a cone having electrically insulated walls, and the tip includes a tapering cross-section having slanted eclectically insulated surfaces, and
wherein the electrically insulated walls of the cone are configured to contact the slanted electrically insulated surfaces of the tip
to align the plurality of electrodes within the plurality of hollow workpieces, and
to prevent uninsulated electrical contact between the plurality of electrodes within the plurality of hollow workpieces.
